(19) United States
(12) Patent Application Publication
(10) Pub. No.: US 2026/0060890 A1
(43) Pub. Date: Mar. 5, 2026

(54) HYBRID SAUNA STOVE

(71) Applicant: Thomas E. Rolando, St. Louis Park, MN (US)

(72) Inventor: Thomas E. Rolando, St. Louis Park, MN (US)

(21) Appl. No.: 19/302,504

(22) Filed: Aug. 18, 2025

Related U.S. Application Data
(60) Provisional application No. 63/691,028, filed on Sep. 5, 2024.

(51) Int. Cl. A61H 33/06; F24H 3/00; F24H 15/208; F24H 15/25; F24H 15/464; H05B 1/02

(52) U.S. Cl. CPC A61H 33/063; F24H 3/002; F24H 3/008; F24H 15/208; F24H 15/25; F24H 15/464; H05B 1/0275; A61H 2033/061; A61H 2201/501; A61H 2201/5082; A61H 2201/5097

(57) ABSTRACT

An example sauna stove can include an open-air container with a plurality of sides and is open at the top, a heat-conductive plate that includes a first surface that acts as a side to the open-air container and a second surface opposite the first surface, an electric heating element that is positioned on the second surface of the heat conductive plate, and a furnace chamber that utilizes the second surface of the heat-conductive plate as a surface to transfer heat generated by the furnace chamber to the open-air container.

### BACKGROUND

Saunas are isolated rooms heated to high temperatures. People use them recreationally because they help muscles relax and open pores. One way to create these high temperatures is by utilizing a heat source to increase a temperature of rocks or other substrate.

### BRIEF DESCRIPTION OF THE DRAWINGS

FIG. 1A illustrates an example of an electric heating and wood fire sauna hybrid with the location of the electric heating element being on the bottom of the open-air container.

FIG. 1B illustrates an example of an electric heating and wood fire sauna hybrid with the location of the electric heating element being on the walls of the open-air container.

FIG. 2A illustrates an example of an interior view of an electric heating and wood fire sauna hybrid with the location of the electric heating element being on the bottom of the open-air container.

FIG. 2B illustrates an example of an interior view of an electric heating and wood fire sauna hybrid with the location of the electric heating element being on the walls of the open-air container.

FIG. 3 illustrates an example of a side and bottom view of an electric heating plate.

FIG. 4A illustrates an example of a side and top view of an electric heating apparatus that is insertable into an existing organic burning sauna stove and would act as the bottom of the existing open-air container.

FIG. 4B illustrates an example of a side and top view of an electric heating apparatus that is insertable into an existing organic burning sauna stove and would act as the walls of the existing open-air container.

FIG. 5 illustrates an example of a device for adjusting electric heating element temperature outputs based on temperature thresholds in the open-air container.

FIG. 6 illustrates an example of a device for adjusting electric heating element temperature outputs based on temperature thresholds in the furnace chamber.

### DETAILED DESCRIPTION

The disclosure generally relates to a hybrid sauna stove. A sauna stove can be utilized to heat a substrate such as, but not limited to sauna rocks, ceramic stones, artificial heat-resistant stones, and/or glass rocks. The sauna stove can utilize indirect heat to prevent emissions from the sauna stove from entering the sauna. For example, the sauna stove can be a wood burning stove that includes a combustion chamber to burn a combustible. In this example, the heat generated from burning the combustible can be utilized to heat the substrate and the exhaust of the combustion chamber can exit the sauna through a chimney. In this way, human users can be within the sauna.

Electric sauna stoves were developed to make sauna installation easier, require lower maintenance, improved safety, and improved durability compared to wood burning sauna stoves. The wood burning sauna stove remains popular with sauna enthusiasts, but can be more difficult to operate and/or maintain. For example, a sauna with a plurality of different users that each may have a different level of experience may find a wood burning sauna stove to be overly complicated or difficult to maintain.

The present disclosure overcomes the deficiencies of wood burning sauna stoves and electric sauna stoves by providing hybrid sauna stoves that can utilize one or both of a wood burning stove and an electric stove to heat the sauna rocks. In this way, a less experienced user can utilize the electric portion of the hybrid sauna stove, and a more experienced user can utilize the wood burning portion of the hybrid sauna stove. In some embodiments, the hybrid sauna stove can include a wireless communication device to allow a remote user to activate the electric stove to pre-heat the sauna rocks prior to starting the wood burning portion. In this way, the hybrid sauna stove described herein can provide all of the benefits of both a sole wood burning stove and a sole electric stove along with additional benefits.

As used herein, the term ‘open-air container’ refers to a receptacle, vessel, or enclosure that maintains at least one surface or portion that permits direct atmospheric air exchange with its internal volume. This may include, but is not limited to, containers having permanent openings, removable covers, permeable surfaces, or any combination thereof that allows ambient air to interact with the container's contents. The term is not limited by specific dimensions or materials of construction.

As used herein, the term ‘plurality of sides’ refers to two or more distinct surfaces, faces, walls, or boundaries that define at least a portion of a structure or object. Each side may be planar or non-planar and may intersect with one or more other sides at any angle. The sides may be formed of the same or different materials and may have the same or different dimensions. The term encompasses both exterior surfaces and interior surfaces that partition or segment a structure and is not limited to any particular geometric configuration or arrangement.

As used herein, the term ‘inside’ refers to the internal volume, region, or space that is at least partially bounded or enclosed by one or more surfaces or structures. The inside may be fully or partially enclosed and may include a space or region that is positioned internal to at least one external boundary or surface. This term encompasses both void spaces and spaces containing material or components, and is not limited by shape, dimensions, or degree of enclosure. The inside may be accessible through one or more openings or may be completely sealed and may be defined by continuous or discontinuous bounding surfaces.

As used herein, the term ‘heat conductive plate’ refers to a planar or non-planar structure fabricated from one or more thermally conductive materials capable of facilitating heat transfer. The plate may be of a thickness, shape, or dimensional proportion and may include surface features, perforations, or internal structures that enhance or modify its heat conduction properties. The term encompasses both homogeneous and composite structures, and may include materials selected from, but not limited to, metal alloys, ceramics, composites, or any combination thereof that enables thermal energy transfer. The plate may be rigid or semi-rigid and may incorporate additional functional features while maintaining its primary heat conductive properties.

As used herein, the term ‘first surface’ refers to a designated surface, face, plane, or boundary of a component or structure that is referenced for purposes of description, orientation, or spatial relationship to other elements. The designation of a surface as ‘first’ is arbitrary and for reference purposes only, and does not necessarily indicate temporal sequence, spatial priority, or functional importance relative to other surfaces. The first surface may be oriented in a particular direction and may intersect, join, or be adjacent to other surfaces of the same or different components.

As used herein, the term ‘second surface’ refers to a designated surface, face, plane, or boundary of a component or structure that is referenced for purposes of description, orientation, or spatial relationship to other elements, including but not limited to the first surface. The designation of a surface as ‘second’ is arbitrary and for reference purposes only, and does not necessarily indicate temporal sequence, spatial priority, or functional importance relative to other surfaces, including the first surface.

As used herein, the term ‘electric heating element’ refers to an electrically powered component, device, or assembly configured to generate thermal energy through the conversion of electrical energy. The element may operate using a selected principle of electrical-to-thermal energy conversion, including but not limited to resistive heating, inductive heating, or other electrothermal effects. The term encompasses both bare and insulated heating elements, and may include resistive wire elements, thick or thin film elements, ceramic elements, composite heating elements, or other structures capable of generating heat when energized by electrical current. The electric heating element may incorporate temperature sensing, control features, thermal protection devices, or electrical connection points, and may be designed for AC or DC operation at various voltages and power levels. The element may be rigid, flexible, or semi-flexible, and may include features for mounting, thermal distribution, or electrical isolation. The term is not limited by specific power ratings, physical dimensions, materials of construction, or particular methods of manufacturing or assembly.

As used herein, the term ‘heat-resistant electric heating element’ refers to an electrically powered component, device, or assembly that is configured to both generate thermal energy through electrical power input and maintain its structural and electrical integrity when exposed to elevated temperatures. The element may be constructed from a material or combination of materials that provide electrical conductivity, thermal resistance, and heat generation capabilities, including but not limited to high-temperature metals, alloys, ceramics, semiconductors, or composite materials. The term encompasses both bare and insulated heating elements, and may include resistive wire elements, thick or thin film elements, ceramic elements, or other structure capable of generating and withstanding heat when energized by electrical current. The heat-resistant electric heating element may incorporate temperature sensing, control features, thermal protection devices, insulation, protective coatings, heat shields, or other features that enhance its thermal performance or durability. The element may be designed for continuous or intermittent operation at elevated temperatures, and may include features for thermal management, electrical connection, or mechanical mounting. The term is not limited by specific operating temperature ranges, power ratings, physical dimensions, or particular electrical characteristics.

As used herein, the term ‘furnace chamber’ refers to an enclosed or partially enclosed space, cavity, or volume that is designed or configured to contain, direct, or facilitate thermal energy. The furnace chamber may be defined by one or more walls, surfaces, or boundaries that may be thermally insulated or thermally conductive, and may include one or more openings for access, ventilation, or the introduction or removal of materials or components. The chamber may operate at a particular temperature range and may employ combustion heating. The furnace chamber may include internal components, structures, or features that affect heat distribution, air flow, or thermal processing efficiency, and may be configured for batch or continuous operation. The term is not limited by size, shape, or specific thermal characteristics.

As used herein, the term ‘frame’ refers to a structural element or assembly that provides support or containment for other components, elements, or materials. The frame may be rigid, semi-rigid, or flexible, and may be constructed from a suitable material or combination of materials. The term encompasses both external supporting structures and internal reinforcing structures and may include a geometric configuration. The frame may be permanent or temporary, fixed or adjustable, and may incorporate features for mounting, attachment, alignment, or interaction with other components. The term is not limited by size, shape, material composition, or specific method of construction or assembly.

As used herein, the term ‘seal’ refers to a device, component, material, or structural arrangement designed to prevent, control, or restrict the passage of matter, energy, or both between two or more regions, surfaces, or components. The seal may be formed from a suitable material or combination of materials, including but not limited to elastomers, metals, composites, or other material capable of providing sealing functionality. The term encompasses both static and dynamic seals, permanent and temporary seals. The seal may be compression-based, interference-based, adhesive-based, or utilize other physical principles to achieve its sealing function. The seal may be single or multi-component, may incorporate additional features such as reinforcements or wear surfaces, and may be designed to operate under various environmental conditions, pressures, or temperatures. The term is not limited by size, shape, material composition, or specific method of implementation or attachment.

As used herein, the term ‘mode’ is used several times and refers to distinct operational states, configurations, conditions, or settings that defines or characterizes the behavior, function, or operation of a system, device, or process. The mode may be determined by user input, automated selection, predetermined conditions, or a combination thereof. The term encompasses both discrete modes with clear boundaries between states and continuous modes with gradual transitions between states. A mode may be temporary or persistent, may be exclusive or concurrent with other modes, and may involve changes in one or more operational parameters, behaviors, or characteristics of the system. The mode may be associated with specific algorithms, procedures, settings, or control parameters that govern the operation of the system during that mode. The term includes, but is not limited to, operating modes, processing modes, control modes, power modes, or other functional states that can be distinguished from other possible states of operation. The term is not limited by the method of mode selection, duration of the mode, or specific characteristics that define the mode.

As used herein, the term ‘account’ refers to a formal arrangement, record, or data structure that establishes and maintains a relationship between a user, entity, or system and a set of associated privileges, resources, data, or services. The account may include, but is not limited to, authentication credentials, user identifiers, access permissions, preferences, historical data, and associated metadata. The term is not limited by the specific implementation technology, storage method, or authentication mechanism used to create, maintain, or access the account.

As used herein, the term ‘passcode’ refers to a sequence, combination, or arrangement of alphanumeric characters, special characters, symbols, biometric data, gestures, or other authenticating elements used to verify identity or grant access privileges. The passcode may be static or dynamic, may have a designated length or complexity, and may combine multiple types of authenticating elements. The term encompasses numeric codes, alphabetic passwords, personal identification numbers (PINs), cryptographic keys, one-time codes, time-based tokens, challenge-response pairs, or other form of security credential. The passcode may be stored, transmitted, or processed in an encrypted or hashed form, and may be input through an interface or input mechanism. The passcode may be temporary or permanent, may expire after a predetermined time or number of uses, and may be subject to complexity requirements or validation rules. The term is not limited by the specific implementation method, storage format, or verification mechanism used to process or validate the passcode

In some aspects, the techniques described herein relate to a sauna stove, including: An open-air container defined by a plurality of sides, an inside, and an opening; a heat conductive plate that may transfer heat into the open-air container, comprising a first surface and a second surface opposite the first surface, the first surface is in contact with at least one side of the open-air container, the second surface comprises an electric heating element; and a furnace chamber that may generate heat that is then transferred into the open-air container. In some aspects, the techniques described herein relate to a sauna stove, wherein heat generated by the electric heating element and the furnace chamber may be transferred through the heat-conductive plate and into the open-air container.

In some aspects, the techniques described herein relate to a sauna stove, wherein the electric heating element and the furnace chamber may be utilized in a first mode wherein the electric heating element and the furnace chamber are used independently, a second mode wherein the electric heating element and the furnace chamber are used cooperatively, and a third mode wherein the electric heating element and the furnace chamber transition from first mode to second mode or second mode to first mode. In some aspects, the techniques described herein relate to a sauna stove, further comprises a wireless access point configured to receive a remote signal that may control the electric heating element.

In some aspects, the techniques described herein relate to a sauna stove, further comprises a processor to receive a temperature value from a temperature sensor located about the open-air container. In some aspects, the techniques described herein relate to a sauna stove, wherein the electric heating element may adjust its temperature based on a processor signal from the processor based on the temperature value it received from the temperature sensor.

In some aspects, the techniques described herein relate to a sauna stove, further comprises a processor to receive a series of temperature values from a series of temperature sensors located about the electric heating element and the furnace chamber. In some aspects, the techniques described herein relate to a sauna stove, wherein the electric heating element may adjust its temperature or turn on or off based on the series of temperature values received by the processor.

In some aspects, the techniques described herein relate to a sauna stove, wherein a series of temperature sensors may be located about but not limited to the outside the sauna stove, the open-air container, the electric heating element, and the furnace chamber. In some aspects, the techniques described herein relate to a sauna stove, wherein readings from the series temperature sensors are sent to a processor which may instruct the electric heating elements operation.

In some aspects, the techniques described herein relate to a sauna stove, wherein the electric heating element is configured to adjust its temperature settings in localized sections of the electric heating element. In some aspects, the techniques described herein relate to a sauna stove, wherein a user can create an account connected to the sauna stove, which may gather information on individual sauna sessions based on sensor data and user input.

In some aspects, the techniques described herein relate to a sauna stove, wherein a user may create a passcode needed to adjust the temperature of the electric heating element or open the furnace chamber. In some aspects, the techniques described herein relate to a sauna stove, wherein the sauna stove is configured to have a user mode, which may apply the user's settings and passcode. In some aspects, the techniques described herein relate to a sauna stove, wherein the sauna stove is configured to have public mode, which may allow general access.

In some aspects, the techniques described herein relate to an electric heating apparatus, including: a heat conductive plate comprising a first surface and a second surface; the first surface is opposite the second surface, the second surface has a heat-resistant electric heating element attached to the second surface; and a frame that attached to the heat conductive plate, configured to creates a seal that isolates the heat-resistant electric heating element from an outside environment when placed in a casing. In some aspects, the techniques described herein relate to an electric heating apparatus,
wherein the heat-resistant electric heating element can withstand high temperatures from other sources.

In some aspects, the techniques described herein relate to an electric heating apparatus, wherein the frame allows the apparatus to be placed within an existing casing. In some aspects, the techniques described herein relate to an electric heating apparatus, wherein the apparatus is able to be placed in a heat-resistant container and act as a new surface of the container.

In some aspects, the techniques described herein relate to a sauna stove, including: an open-air container defined by a plurality of sides, an inside, and an opening; a heat conductive plate comprising a first surface, a second surface, and a frame; the first surface is opposite the second surface, the second surface has a series of heat-resistant electric heating element attached to the surface at a plurality of points; the frame is configured to creates a seal that isolates the heat-resistant electric heating element from an outside environment when placed in an appropriate casing; and a furnace chamber that may generate heat that is then transferred into the open-air container.

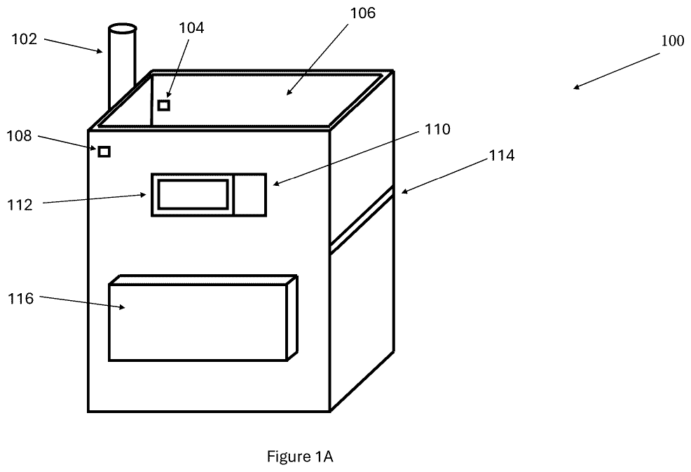

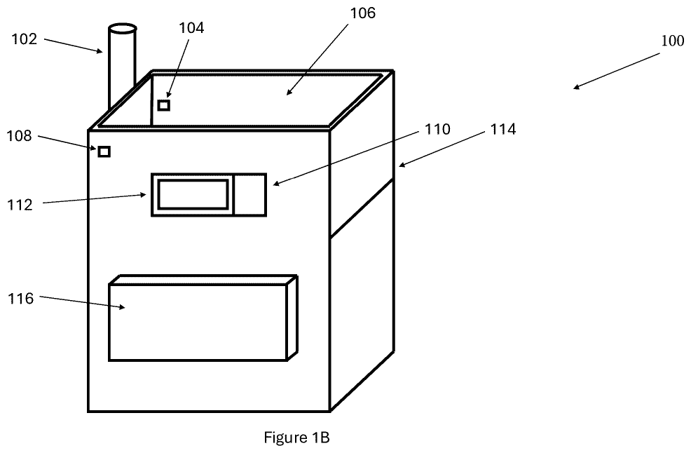

FIG. 1A illustrates an example of an exterior of a sauna stove 100 that has both electric heating functions and organic burning functions in which the electric heating element affects the bottom of the open-air container 106.

The sauna stove 100 has an open-air container 106, in which there is a series of temperature sensors 104 which read the temperature of the open-air container 106. As described herein, the open-air container 106 can be a receptacle, vessel, or enclosure that maintains at least one surface or portion that permits direct atmospheric air exchange with its internal volume.

In some embodiments, the open-air container 106 can be a container that can be exposed to the area within a sauna. For example, the sauna stove 100 can be positioned such that the open-air container 106 can be exposed to the interior of the sauna. In this way, the sauna stove 100 can be utilized to heat a substrate (e.g., rocks, etc.) positioned within the open-air container 106 and the heat of the rocks can be transferred to the air within the sauna.

As described herein, the open-air container 106 can include a plurality of temperature sensors 104. The plurality of temperature sensors 104 can be utilized to monitor a temperature within the area of the open-air container 106. In this way, the plurality of temperature sensors 104 can be utilized to monitor a temperature of the substrate or rocks positioned within the open-air container 106. As described herein, the temperature identified by the plurality of temperature sensors 104 can be utilized to determine when the sauna stove 100 is at a temperature that provides enough heat to bring an air temperature of the sauna to a desired level. In this way, the plurality of temperature sensors 104 can be utilized by a computing device 112 for activating or deactivating an electrical heat source.

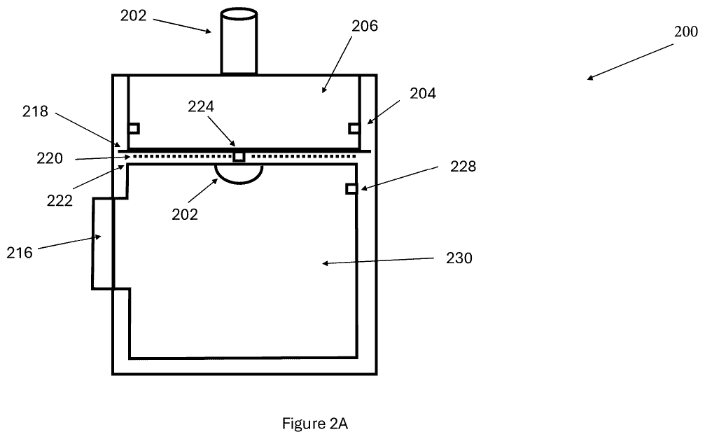

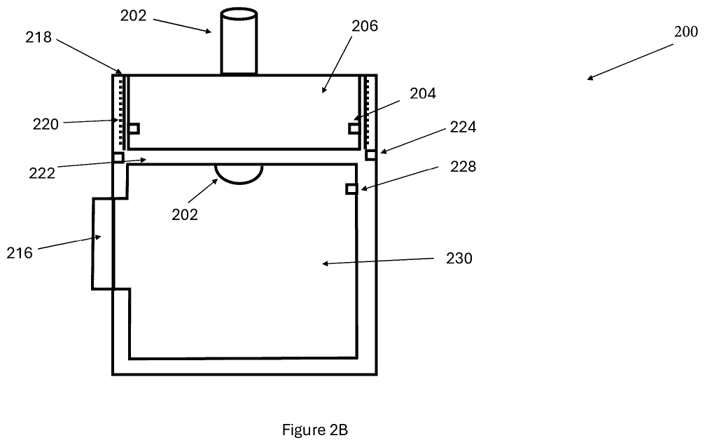

On the exterior of the sauna stove 100 is a baffle 102, used to direct byproduct produced by the furnace chamber (e.g., furnace chamber 230 as referenced in FIG. 2A and FIG. 2B, etc.). In some embodiments, the baffle 102 can refer to a chimney that is utilized to direct exhaust from combustion within the furnace chamber to an area outside the sauna. In this way, the baffle 102 can prevent dangerous gases from the furnace chamber from entering the sauna that includes human occupants.

In some embodiments, the sauna stove 100 can include an electronically locked door 116 which opens to the furnace chamber. In some embodiments, the electronically locked door 116 can prevent access to the furnace chamber (e.g., combustion chamber, etc.). As described herein, the furnace chamber can be dangerous or difficult to utilize for a user that is not an experienced user of a furnace style sauna. In this way, the electronically locked door 116 can be utilized to prevent users without credentials that are associated with more experienced users.

A computing device 112 and a control pad 110. In some embodiments, the control pad 110 can allow a user to interact with the computing device 112. For example, the control pad 110 can be utilized to enter credentials that can activate or deactivate the electronically locked door 116. In other examples, the control pad 110 can be utilized to activate or deactivate a heat conductive plate. In these embodiments, the control pad 110 and/or computing device 112 can be accessed remotely to allow a remote user to control the electronically locked door 116 and/or the heat conductive plate.

A slot 114 from which the heat conductive plate (e.g., conductive plate 218 as referenced in FIG. 2A and FIG. 2B, etc.) and the electronic heating element can be removed from the side for maintenance. As described further herein, the slot 114 can be a space to allow the heat conductive plate to interact with a surface of the open-air container 106 when the heat conductive plate is installed within the slot 114.

FIG. 1B illustrates an example of an exterior of a sauna stove that has both electric heating functions and organic burning functions in which the electric heating element affects the plurality of sides of the open-air container 106. The only difference between FIG. 1A and FIG. 1B is the position of the slot 114 from which the heat conductive plate 218 and the electronic heating element 220 can be removed. In this figure they can be removed from the top.

FIG. 2A illustrates an example of an interior of a sauna stove that has both electric heating functions and organic burning functions in which the electric heating element affects the floor of the open-air container 206. The sauna stove has an open-air container 206, in which there is a series of heat sensors 204 which read the temperature of the open-air container 206. Below the open-air container 206 is the heat conductive plate 218 which makes contact across the entirety of the open-air containers 206 floor. Attached to the heat conductive plate 218 is a series of electric heating elements 220 that transfer heat through the heat conductive plate 218 to the open-air container 206. A series of heat sensors 224 which read the temperature of the space between the heat conductive plate 218 and the furnace chamber roof 222. Below the furnace chamber roof 222 is the furnace chamber 230 which has an electronically locked door 216, a baffle 202, and its own series of heat sensors 228 which read the temperature of the furnace chamber 230.

FIG. 2B illustrates an example of an interior of a sauna stove that has both electric heating functions and organic burning functions in which the electric heating element affects the walls of the open-air container 206. The only difference between FIGS. 2A and 2B is the position of the heat conductive plate 218 and the electric heating element 220 have moved from making contact all across the bottom of the open-air container 206 to making contact all along the walls of the open-air container 206.

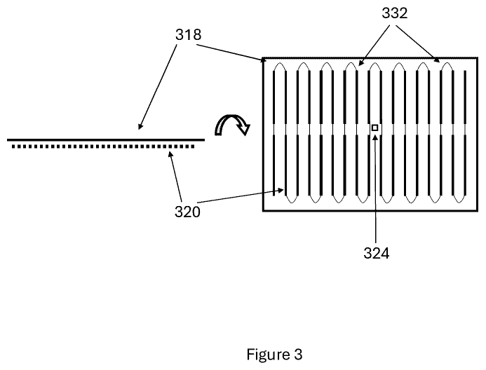

FIG. 3 illustrates an example of a side and bottom view of an electric heating plate. The electric heating plate is made up of two main parts, the heat conductive plate 320 and the electric heating element 318. The electric heating element 318 is attached to the heat conductive plate 320 so it all works as one piece and so heat transfer is efficient. The electric heating element 318 is made up of a series of electric heating elements 318 that are able to heat up to different temperatures independently and are connected by a heat-resistant wire 332. Additionally, a series of heat sensors 324 are attached to the heat conductive plate in order to read the temperature of the environment that the electric heating element 318 are in.

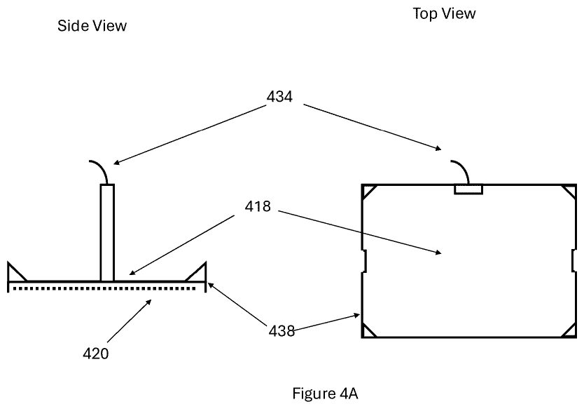

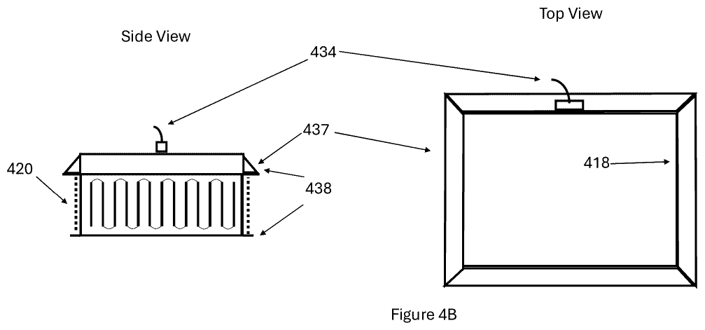

FIG. 4A illustrates an example of a side and top view of an electric heating apparatus that is insertable into an existing organic burning sauna stove and would act as the bottom of the existing open-air container. The electric heating apparatus is made from a heat conductive plate 418, a series of electric heating element 420, a protective wire casing 434, and heat-resistant sealing material 438. The heat conductive plate 418 and the series of electric heating elements 420 are of the same design and make up as described in FIG. 3. The heat-resistant sealing material 438 is attached to the heat conductive plate 418, around its perimeter, on the same side as the electric heating elements 420. The heat-resistant sealing material 438 is meant to provide insulation for the series of electric heating elements 420 and create space between the open-air container floor and the series of electric heating elements 420. The dimensions of the electric heating apparatus must be made in accordance with the dimensions of the existing open-air container it would fit in. The length and width of the heat conductive plate 418 must match that of the floor of the open-air container while the height of protective wire casing must be as long or longer than the depth of the open-air container.

FIG. 4B illustrates an example of a side and top view of an electric heating apparatus that is insertable into an existing organic burning sauna stove and would act as the walls of the existing open-air container. The electric heating apparatus is made from a heat conductive plates 418, a series of electric heating elements, a protective wire casing 434, an over hanging lip 437, and heat-resistant sealing material 438. The heat conductive plates 418 and the electric heating elements 420 are of the same design and make up as described in FIG. 3. The heat-resistant sealing material 438 is attached to the heat conductive plates 418, along its upper and lower parameters, on the same side as the electric heating elements 420. The heat-resistant sealing material 438 is meant to provide insulation for the electric heating elements 420 and create space between the open-air container walls and the electric heating elements 420. The overhanging lip 437 is attached to the upper perimeter of the heat conductive plates 418 and is meant to rest the electric heating apparatus on the rim on the open-air container it is inserted into so that all the weight is not focused on the bottom. The dimensions of the electric heating apparatus must be made in accordance with the dimensions of the existing open-air container it would fit in. The heat conductive plates 418 must match the height of the walls of the open-air container but they must be slightly shorter in length so that they can slide into the open-air container and allow the heat-resistant sealing material 438 to fit tightly against the walls.

A user may utilize a computing device for various purposes, such as for business and/or recreational use. As used herein, the term computing device refers to an electronic device having a processor and a memory resource. Examples of computing devices can include, for instance, a laptop computer, a notebook computer, a desktop computer, an all-in-one (AIO) computer, and/or a mobile device (e.g., a smart phone, tablet, personal digital assistant, smart glasses, a wrist-worn device, etc.), among other types of computing devices. Computing devices can be utilized to perform a plurality of computing functions. Computing devices utilize a plurality of components (e.g., hardware computing components, etc.) to perform the functions. In some examples, the plurality of components generate heat when performing the plurality of functions.

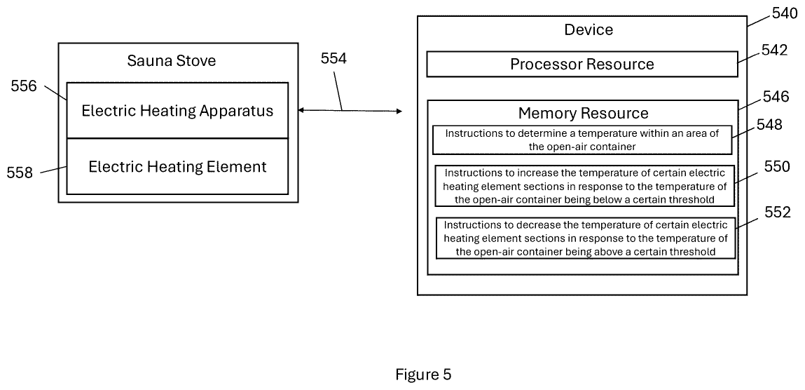

FIG. 5 illustrates an example of a device 540 for adjusting electric heating element temperature outputs based on temperature thresholds in the open-air container. In some examples, the device 540 includes a processor resource 542 and a memory resource 546 to store instructions that are executed by the processor resource 542. In some examples, the device 540 includes a computing device that includes a processor resource 542 and a memory resource 546 storing instructions 548, 550, 552 that can be executed by the processor resource 542 to perform particular functions.

The device 540 includes instructions 548 stored by the memory resource 546 that is executed by the processor resource 542 to determine a temperature within an area of the open-air container. In some embodiments, temperature sensors can be communicatively coupled to the device 540 to provide temperature readings from a plurality of different locations. For example, the temperature sensors can be positioned within the sauna, within the furnace chamber, within an electric portion of the sauna stove, and/or other locations associated with the sauna.

The device 540 includes instructions 550 stored by the memory resource 546 that is executed by the processor resource 542 to increase the temperature of certain electric heating element sections in response to the temperature of the open-air container being below a certain threshold. In some embodiments, the open-air container can include temperature sensors that can be an indicator of whether the temperature of the sauna rocks are at a desired temperature.

When the sauna rocks fall below the desired temperature threshold, the device 540 can activate or increase a heat generated by the electric heating element. In some embodiments, the fall in temperature of the sauna rocks can indicate that the wood fire stove may no longer be generating enough heat to maintain a particular temperature of the sauna rocks.

The device 540 includes instructions 552 stored by the memory resource 546 that is executed by the processor resource 542 to decrease the temperature of certain electric heating element sections in response to the temperature of the open-air container being above a certain threshold. In some embodiments, the temperature sensors can provide a signal to the device 540 to indicate that the temperature of the open-air container has exceeded a temperature threshold. In some embodiments, the temperature of the open-air container exceeding a threshold temperature can indicate that the combustion chamber or furnace chamber is generating enough heat to maintain a temperature of the sauna rocks. In this way, the electric heating element can be deactivated when the combustion chamber is able to maintain the heat of the sauna rocks. In some embodiments, this can allow a user to pre-heat the sauna rocks while the combustion chamber heats up or while the combustion chamber is being set up for use.

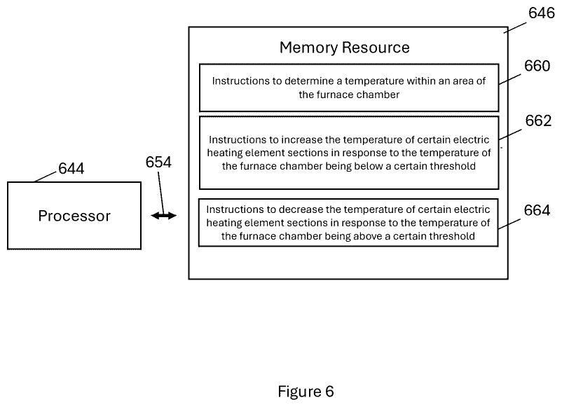

FIG. 6 illustrates an example of a memory resource 646 for adjusting electric heating element temperature outputs based on temperature thresholds in the furnace chamber. In some examples, the memory resource 646 can be a part of a computing device or controller that can be communicatively coupled to a computing system. For example, the memory resource 646 can be part of a device 540 as referenced in FIG. 5. In some examples, the memory resource 646 can be communicatively coupled to a processor 644 that can execute instructions 660, 662, 664, stored on the memory resource 646. For example, the memory resource 646 can be communicatively coupled to the processor 644 through a communication path 654. In some examples, a communication path 654 can include a wired or wireless connection that can allow communication between devices and/or components within a single device.

The memory resource 646 may be electronic, magnetic, optical, or other physical storage device that stores executable instructions. Thus, a non-transitory machine-readable medium (MRM) (e.g., a memory resource 646) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., a memory resource 646) may be disposed within a controller and/or computing device. In this example, the executable instructions 660, 662, 664, can be “installed” on the device. Additionally, and/or alternatively, the non-transitory machine-readable medium (e.g., a memory resource) can be a portable, external, or remote storage medium, for example, that allows a computing system to download the instructions 660, 662, 664, from the portable/external/remote storage medium. In this situation, the executable instructions may be part of an “installation package”. As described herein, the non-transitory machine-readable medium (e.g., a memory resource 646) can be encoded with executable instructions for altering a temperature of a sauna stove by activating or deactivating an electric heat source, providing or restricting access to a wood stove, and/or providing remote activation for the sauna stove.

In some examples, the memory resource 646 can include instructions 660 to determine a temperature within an area of the furnace chamber. In some examples, the memory resource 646 can include instructions 662 to increase the temperature of certain electric heating element sections in response to the temperature of the furnace chamber being below a certain threshold. In some examples, the memory resource 646 can include instructions 664 to decrease the temperature of certain electric heating element sections in response to the temperature of the furnace chamber being above a certain threshold.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A sauna stove, comprising:
an open-air container defined by a plurality of sides, an inside, and an opening;
a heat-conductive plate that transfers heat into the open-air container, comprising:
a first surface and a second surface opposite the first surface;
the first surface is in contact with at least one side of the open-air container; and
the second surface comprises an electric heating element; and
a furnace chamber that generates heat that is then transferred into the open-air container.

2. The sauna stove of claim 1, wherein heat generated by the electric heating element and the furnace chamber is transferred through the heat-conductive plate to the open-air container.

3. The sauna stove of claim 1, wherein the electric heating element and the furnace chamber is utilized in:
a first mode when the electric heating element and the furnace chamber are used independently;
a second mode when the electric heating element and the furnace chamber are used cooperatively; and
a third mode when the electric heating element and the furnace chamber transitions from the first mode to the second mode or from the second mode to the first mode.

4. The sauna stove of claim 1, further comprising a wireless access point configured to receive a remote signal that controls the electric heating element.

5. The sauna stove of claim 1, further comprising a processor to receive a temperature value from a temperature sensor located about the open-air container.

6. The sauna stove of claim 5, wherein the processor is configured to adjust a temperature of the electric heating element based on the temperature value it received from the temperature sensor.

7. The sauna stove of claim 1, further comprising a processor to receive a series of temperature values from a series of temperature sensors located at the electric heating element and the furnace chamber.

8. The sauna stove of claim 7, wherein the processor is configured to alter a temperature of the electric heating element, activate the electric heating element, or deactivate the electric heating element based on the series of temperature values.

9. The sauna stove of claim 1, wherein a series of temperature sensors are located outside the sauna stove, the open-air container, the electric heating element, and the furnace chamber.

10. The sauna stove of claim 9, further comprising a processor to receive temperature values from the series of temperature sensors and alter an operation of the electric heating elements based on the temperature values.

11. The sauna stove of claim 1, wherein the electric heating element is configured to adjust temperature settings in localized sections of the electric heating element.

12. The sauna stove of claim 1, further comprising a processor to create an account connected to the sauna stove associated with a user and collect information related to individual sauna sessions for the user.

13. The sauna stove of claim 12, wherein the account includes a passcode needed to adjust a temperature of the electric heating element or the open the furnace chamber.

14. The sauna stove of claim 13, wherein account includes a user mode to apply settings associated with the user in response to receiving the passcode.

15. The sauna stove of claim 14, wherein the account includes a public mode to allow general access with default settings.

16. An electric heating apparatus, comprising:
a heat conductive plate comprising a first surface and a second surface, wherein the first surface is opposite the second surface and the second surface has an attached heat-resistant electric heating element; and
a frame that is attached to the heat conductive plate, configured to create a seal to isolate the heat-resistant electric heating element from an outside environment when positioned within a casing.

17. The electric heating apparatus of claim 16, wherein the heat-resistant electric heating element can withstand heat generated by other heat sources.

18. The electric heating apparatus of claim 16, wherein the frame allows the apparatus to be placed within an existing casing.

19. The electric heating apparatus of claim 16, wherein the apparatus is able to be placed in a heat-resistant container and act as a different surface of the container.

20. A sauna stove, comprising:
an open-air container defined by a plurality of sides, an inside, and an opening;
a heat conductive plate comprising a first surface, a second surface, and a frame, wherein the first surface is opposite the second surface and the second surface has a series of heat-resistant electric heating element attached at a plurality of points;
the frame is configured to create a seal that isolates the heat-resistant electric heating element from an outside environment when placed in a casing; and
a furnace chamber that generates heat via combustion, wherein the heat is transferred into the open-air container.
